(19) United States
(12) Patent Application Publication
(10) Pub. No.: US 2011/0058022 A1
(43) Pub. Date: Mar. 10, 2011

(54) APPARATUS AND METHOD FOR PROCESSING IMAGE DATA IN PORTABLE TERMINAL

(75) Inventor: Kwang-Cheol CHOI, Gwacheon-si (KR)

(73) Assignee: Samsung Electronics Co., Ltd., Suwon-si (KR)

(21) Appl. No.: 12/879,408

(22) Filed: Sep. 10, 2010

(30) Foreign Application Priority Data
Sep. 10, 2009 (KR) 10-2009-0085237

(51) Int. Cl. G06K 9/62; H04N 13/02

(52) U.S. Cl. 348/46; 382/154; 348/E13.074

(57) ABSTRACT

An apparatus and a method for processing image data in a portable terminal are provided. More specifically, an apparatus and a method are provided for reducing computation in similar block estimation of left and right image data when an image is compressed or a stereoscopic image is processed. The apparatus includes a camera for obtaining two or more image data; and a similar block detector for converting the obtained image data to binary data and estimating block similarity by comparing the converted binary data.

### PRIORITY

The present application claims priority under 35 U.S.C. §119(a) to a Korean Patent Application filed in the Korean Intellectual Property Office on Sep. 10, 2009, and assigned Serial No. 10-2009-0085237, the entire disclosure of which is hereby incorporated by reference.

### BACKGROUND OF THE INVENTION

1. Field of the Invention

The present invention relates generally to an apparatus and a method for processing image data in a portable terminal, and more particularly, to an apparatus and a method for reducing computation of similar block estimation of left and right image data required to compress an image or to process a stereographic image in a portable terminal.

2. Description of the Related Art

With the rapid advance of portable terminals, portable terminals allowing wireless voice communication and information exchange have become an essential item in life. Initially, the portable terminals simply featured portability and wireless communication. As technologies of the portable terminal develop and the wireless Internet was introduced, uses of the portable terminal have expanded to include games, remote control using short-range communication, image capturing using an embedded digital camera, and the like. As such, the utilization of the portable terminal is expanding to satisfy the varied wants of users.

Moreover, portable terminals capable of sending and receiving digital image data have recently been introduced. Such portable terminals use video compression technology to send and receive the digital image data.

A basic principle of digital image data compression eliminates redundancy of the data. Data may be compressed by reducing spatial redundancy when the same color or object is repeated in the image, temporal redundancy when temporally contiguous video frames are changed little or the same sound is repeated in the audio, or psychological visual redundancy considering that human's vision and perception are dull to high frequencies.

The portable terminal compresses the image data by estimating block similarity using Sum of Absolute Difference (SAD) of the blockwise image. However, a method for estimating the block similarity using the blockwise image difference requires much computation. In particular, to determine the blockwise similarity of left and right images for stereographic image processing, its search range is widened, which requires much computation.

In this regard, a great number of methods have been attempted to reduce the computation in the block similarity estimation, but these methods degrade compression efficiency because of considerable estimation errors as the computation is reduced.

To address these drawbacks, an apparatus and a method for reducing computation required to estimate the block similarity and efficiently determining the block similarity are needed.

### SUMMARY OF THE INVENTION

The present invention has been made to substantially solve at least the above problems and/or disadvantages and to provide at least the advantages below. Accordingly, an aspect of the present invention to provide an apparatus and a method for reducing computation in image data processing in a portable terminal.

Another aspect of the present invention is to provide an apparatus and a method for estimating similar blocks of image data with less computation in a portable terminal.

Yet another aspect of the present invention is to provide an apparatus and a method for reducing computation in block similarity determination by generating virtual frames with binary data, comparing blocks of the virtual frames, and determining the similarity between the blocks in a portable terminal.

In accordance with an aspect of the present invention, an apparatus for estimating block similarity of image data in a portable terminal includes a camera for obtaining two or more image data; and a similar block detector for converting the obtained image data to binary data and estimating block similarity by comparing the converted binary data.

In accordance with another aspect of the present invention, a method for estimating block similarity of image data in a portable terminal includes obtaining two or more image data; converting the obtained image data to binary data; and estimating block similarity by comparing the converted binary data.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram of a portable terminal for determining similar blocks with less computation according to an embodiment of the present invention;

FIG. 2 is a flowchart of a method for determining similarity between a reference image and a comparison image in the portable terminal according to an embodiment of the present invention;

FIG. 3 is a flowchart of a method for converting the reference image and the comparison image to binary images in the portable terminal according to an embodiment of the present invention;

FIG. 4 is a flowchart of a method for determining block similarity using binary image data in the portable terminal according to an embodiment of the present invention;

FIG. 5 is a diagram of the process for determining the similar blocks in the portable terminal according to an embodiment of the present invention;

FIG. 6A is a diagram of image data obtained through two cameras in the portable terminal according to an embodiment of the present invention;

FIG. 6B is a diagram of data converted to a gray image using only intensity information in the portable terminal according to an embodiment of the present invention;

FIG. 6C is a diagram of the gray data converted to the binary image in the portable terminal according to an embodiment of the present invention; and

FIG. 6D is a diagram of the block similarity determination in the portable terminal according to an embodiment of the present invention.

Throughout the drawings, like reference numerals will be understood to refer to like parts, components and structures.

### DETAILED DESCRIPTION OF EMBODIMENTS OF THE INVENTION

The following description with reference to the accompanying drawings is provided to assist in a comprehensive understanding of embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Further, the terms and words used in the following description and claims are not limited to their dictionary meanings, but are merely used to enable a clear and consistent understanding of the invention. Accordingly, it should be apparent to those skilled in the art that the following description of embodiments of the present invention is provided for illustration purposes only and not for the purpose of limiting the invention as defined by the appended claims and their equivalents.

Embodiments of the present invention provide an apparatus and a method for reducing computation generated when image data is processed, according to block similarity determination by generating a virtual frame with binary data, comparing blocks of the generated virtual frame, and determining similarity between the blocks.

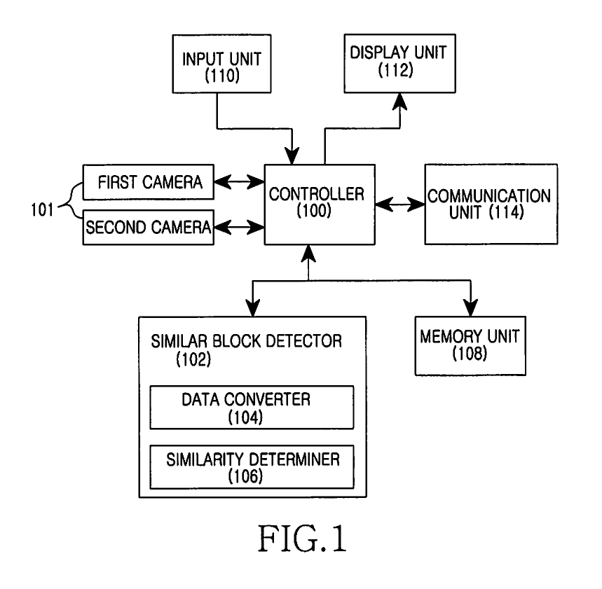

FIG. 1 is a block diagram of a portable terminal for determining similar blocks with less computation according to an embodiment of the present invention.

Referring to FIG. 1, a portable terminal includes a controller 100, a camera unit 101, a similar block detector 102, a memory unit 108, an input unit 110, a display unit 112, and a communication unit 114. The similar block detector 102 can further include a data converter 104 and a similarity determiner 106. The portable terminal may include additional units. Similarly, the functionality of two or more of the above units may be integrated into a single component.

The controller 100 of the portable terminal controls operations of the portable terminal. For example, the controller 100 controls the process for voice communication and data communication. In addition to its typical functions, the controller 100 rapidly detects similar blocks with less computation when the blockwise image similarity is estimated to compress the image or to process a stereographic image. That is, to detect the similar blocks with less computation, the controller 100 converts a reference image and a comparison image to binary image data using image data obtained through the cameras 101, and determines the similarity between the blocks by comparing blocks of the binary image data corresponding to the reference image and the comparison data.

In more detail, the controller 100 divides the image data into a plurality of blocks by setting one of left and right images as the reference image, and then determines a DC average value of the whole reference image frame by performing a Discrete Cosine Transform (DCT) process on the divided blocks. Next, the controller 100 generates a register including the DC average value; that is, a register indicating the DC average value of the reference image frame, and then sets every upper bit representing the first “1” from the Most Significant Bit (MSB) of the register, to “1”. Next, the controller 100 generates a virtual frame representing a difference of the DC average and the pixel with “0” or “1” with respect to the whole frame by comparing the register set to “1” with pixels of the other image data.

Next, the controller 100 determines the similarity by comparing virtual frames of the reference image and the comparison image.

The camera unit 101 includes a plurality of cameras, for example, a first camera and a second camera. According to a direction of the controller 100, the camera unit 101 obtains image data of the same time point at different locations.

The similar block detector 102 controls the data converter 104 to convert the reference image and the comparison image to the binary image data using the image data obtained by the cameras 101. The similar block detector 102 generates virtual frames indicating the relation of the pixels and the average DC value using the binary data of the converted binary image data, i.e. by using the binary data of the reference image and the comparison image. Also, the similar block detector 102 controls the similarity determiner 106 to determine the similarity per block by comparing the generated virtual frames of the reference image and the comparison image.

The memory unit 108 includes a ROM, a RAM, a flash ROM, and the like. The ROM contains microcodes and reference data of programs for processing and controlling the controller 100 and the similar block detector 102.

The RAM, which is a working memory of the controller 100, stores temporary data being generated in the program executions. The flash ROM contains various updatable reference data such as a phone book, outgoing messages, and incoming messages. In this embodiment, the flash ROM stores the virtual frames generated by the data converter 104 of the similar block detector 102.

The input unit 110 includes a plurality of function keys such as number buttons 0˜9, a menu button, cancel button, OK button, call button, end button, Internet access button, navigation key buttons, letter input keys, and the like. The input unit 110 provides the controller 100 with key input data (for example, image capturing) corresponding to the key pressed by the user.

The display unit 112 displays status information, a limited number of letters, videos, and still images in the operations of the portable terminal. The display unit 112 may be a color Liquid Crystal Display (LCD), an Active Mode Organic Light Emitting Diode (AMOLED), and the like. When the display unit 112 includes a touch input device and is applied to a touch-type portable terminal, the display unit 112 may be used as an input device.

The communication unit 114 sends and receives radio signals of the input/output data over an antenna (not illustrated). For example, during transmission, the communication unit 114 channel-codes, spreads, RF-processes, and transmits data. During reception, the communication unit 114 converts the received RF signal to a baseband signal and restores the data by de-spreading and channel-decoding the baseband signal.

While the controller 100 of the portable terminal can function as the similar block detector 102, they are separately illustrated for ease of understanding, not to limit the scope of the invention. One skilled in the art shall appreciate that various modifications may be made without departing from the scope and spirit of the invention. For example, the controller 100 may process all of the functions of the similar block detector 102.

So far, the above description provides the apparatus for reducing the computation when the image data is processed in the portable terminal according to the block similarity determination by generating the virtual frames with the binary data and comparing the blocks of the generated virtual frames. Now, a method for reducing the computation according to the block similarity determination using the apparatus according to an embodiment of the present invention is illustrated.

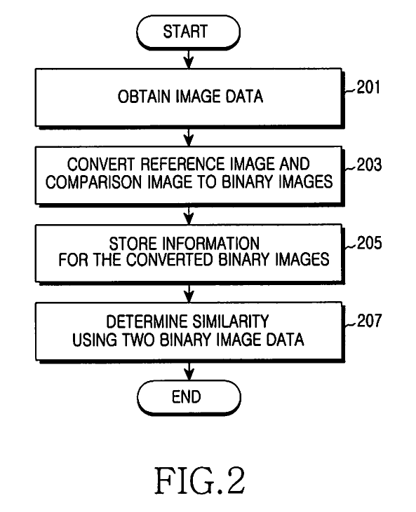

FIG. 2 is a flowchart of a method for determining the similarity between the reference image and the comparison image in the portable terminal according to an embodiment of the present invention.

Referring to FIG. 2, the portable terminal obtains the image data in step 201 and converts the obtained image data to the binary image in step 203. Herein, the portable terminal, which includes two or more cameras, converts the reference image and the comparison image of the image data acquired through the cameras, to a gray image having only intensity information and to convert the gray images to the binary images.

Next, the portable terminal stores the converted binary images to the memory by the bit in step 205.

The portable terminal compares the binary data of the reference image and the comparison image, and determines their similarity in step 207.

Herein, the portable terminal determines the similarity by examining the binary data indicating the difference of the blockwise pixels of the reference image and the comparison image and the DC average. As the data indicating the difference of the pixels and the DC average increases, the portable terminal may determine a lower similarity.

Next, the portable terminal finishes this process.

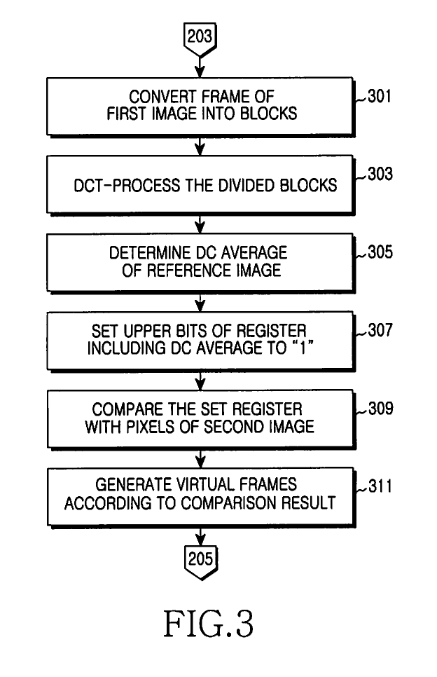

FIG. 3 is a flowchart of a method for converting the reference image and the comparison image to the binary images in the portable terminal according to an embodiment of the present invention.

Referring to FIG. 3, the portable terminal divides the frame of the first image, which is one of the image data obtained by driving the two cameras at the same time, into the plurality of the blocks in step 301, and performs the Discrete Cosine Transform (DCT) on the divided blocks, in step 303.

Herein, the blocks divided in step 301 are blockwise data for the DCT, and indicate the blocks for searching the blocks of the comparison image similar to the blocks of the reference image. The portable terminal conducts the DCT on the divided blocks based on Equation (1).

$${X}_{u , v} = \frac{4}{NM} {C}_{u} {C}_{v} {\sum }_{n = 0}^{N - 1} {\sum }_{m = 0}^{M - 1} {x}_{n , m} COS [ \frac{( 2 n + 1 ) u π}{2 N} ] COS [ \frac{( 2 m + 1 ) v π}{2 M} ] \\ {C}_{k} = ( \begin{matrix}1 / \sqrt{2} , & k = 0 \\ 1 , & k \neq 0\end{matrix} \qquad ( 1 )$$

The DCT method is well known in the art and thus shall not be explained in detail.

In step 305, the portable terminal determines the DC average of the reference image.

Next, the portable terminal locates the first ‘1’ from the MSB of the register including the DC average and sets all of the upper bits including the first ‘1’ to ‘1’ in step 307, and compares the set register with the pixels of the second image in step 309.

For example, when the DC average determined in step 305 is “0000100000”, the portable terminal sets the register including the DC average to “1111000000” in step 307. Next, the portable terminal can compare the set register with the pixels of the second image using an AND operation in step 309.

In step 311, the portable terminal generates the binary image data, which is the virtual frame, according to the comparison result.

In step 311, the portable terminal determines whether the MSB of the non-zero register is “0” or “1” in the register according to the comparison of step 309, compares the whole frame pixels with the magnitude of the DC average, and converts to the binary image data constituted with “0”s and “1”s. Herein, the MSB “1” of the non-zero register implies that the pixel of the second image is greater than the DC average of the reference image, and the MSB “0” of the non-zero register implies that the pixel of the second image is less than the DC average of the reference image.

Next, the portable terminal goes to step 205 of FIG. 2 and stores information of the converted binary images.

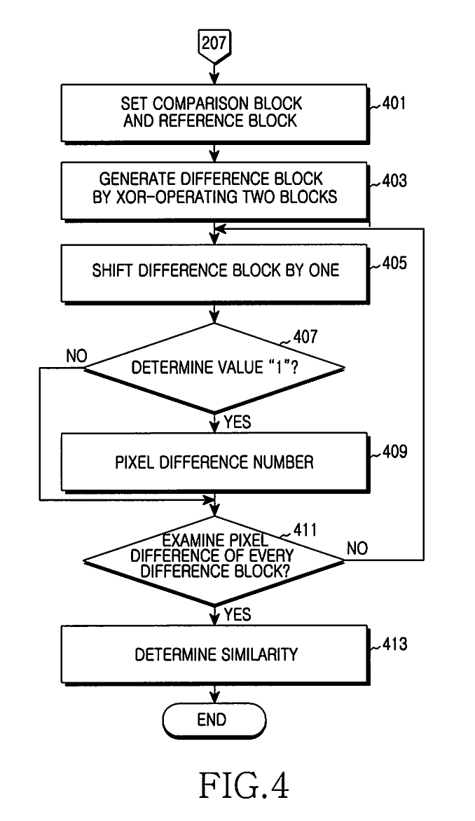

FIG. 4 is a flowchart of a method for determining the block similarity using the binary image data in the portable terminal according to an embodiment of the present invention.

Referring to FIG. 4, the portable terminal sets the comparison block and the reference block to determine the block similarity in step 401, and generates a difference block by XOR operating the two blocks in step 403. Herein, the difference block indicates an XOR operated block of the comparison block and the similar block.

Next, the portable terminal determines the block similarity. Herein, the block similarity may be examined by determining the number of the bits “1” in the difference block generated in step 403, which is explained now.

To determine the block similarity, the portable terminal shifts the difference block generated in step 403 by one in step 405, and determines whether the bit value of the difference block shifted in step 405 is “1” in step 407.

If it is determined in step 407 that the bit value of the shifted difference block is “1”, the portable terminal increases the pixel difference number by one in step 409 and determines whether the pixel difference of every difference block is examined in step 411.

Meanwhile, if it is determined in step 407 that the bit value of the shifted difference block is “0”, the portable terminal proceeds to step 411.

If it is determined in step 411 that the pixel difference of every difference block is not examined, the portable terminal returns to step 405 and determines the pixel difference with respect to all of the difference blocks.

If it is determined in step 411 that the pixel difference of every difference block is examined, the portable terminal determines the block similarity in step 413.

The portable terminal determines the similarity between the blocks by converting the image data obtained through the two cameras to binary data. In more detail, the portable terminal determines the block similarity using the increased pixel difference number in step 409. For example, the portable terminal determines the similarity using the value of the difference block obtained by XOR-operating the binary data of the reference block and the binary data of the comparison block. That is, for a greater pixel difference number, i.e. for more bit value “1”s of the difference block, the portable terminal may determine a low similarity and a great pixel difference between the reference block and the similar block.

Next, the portable terminal finishes this process.

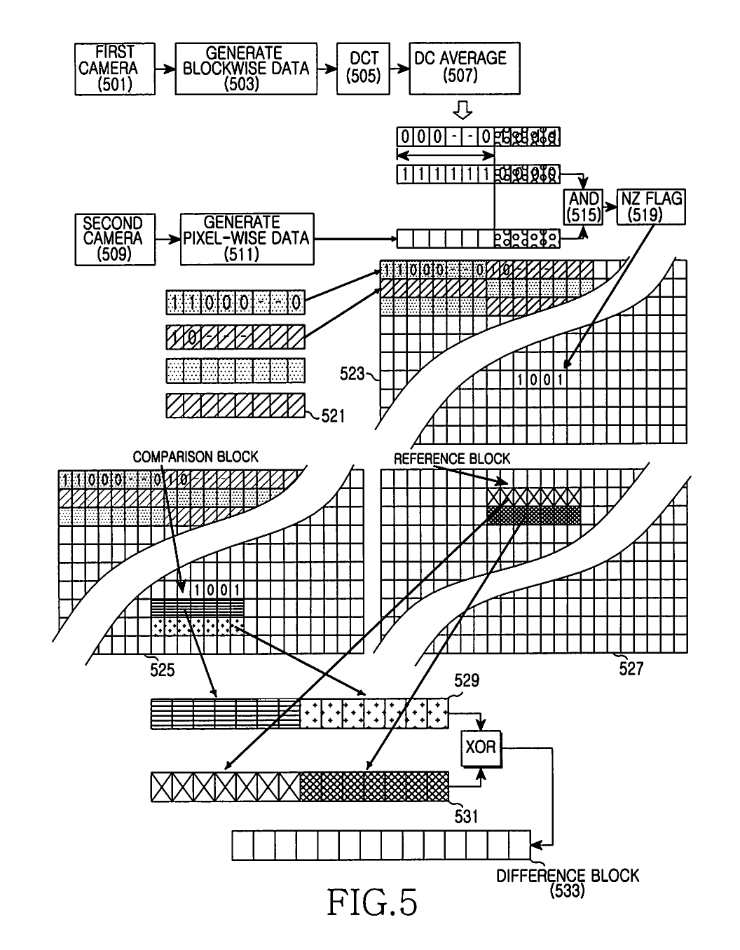

FIG. 5 shows a process for determining the similar blocks in the portable terminal according to an embodiment of the present invention.

Referring to FIG. 5, the portable terminal generates data for the images obtained by driving the first camera 501 and the second camera 509 at the same time.

As shown in FIG. 5, the portable terminal selects the image obtained through the first camera 501 as the reference image, generates the blockwise data divided into the plurality of the blocks in 503, performs DCT 505 on the generated blockwise data 503, determines the DC average 507 of the image obtained through the first camera 501, and thus generates the register including the DC average. Next, the portable terminal determines which bit from the MSB represents the first “1” in the generated register, and sets all of the upper bits to “1”.

Next, the portable terminal conducts an AND operation 515 to generate pixel-wise data 511 of the image obtained through the second camera 509 and the data with the upper bits set to “1” and thus generates the binary data according to the comparison result. The portable terminal determines whether the upper bit of the non-zero register is “0” or “1” in the register according to the comparison in step 519, compares the magnitude of the DC average with the whole frame pixels, and thus converts to the binary image data including “0”s and “1”s. For the bit operation, the portable terminal may store the binary virtual frames to the memory in step 523, or efficiently store in the memory in accordance with the virtual frames in step 521 when 16-bit or 32-bit operation is possible.

Using the above method, the portable terminal generates and stores the virtual frames for the two image data, and measures the similarity between the blocks by comparing the binary data 527 of the reference block and the binary data 525 of the comparison block. In so doing, the portable terminal determines the similarity using the value of the difference block 533 produced by XOR-operating the binary data 531 of the reference block and the binary data 529 of the comparison block. For the greater number of “1”s of the difference block implying a great pixel difference between the reference block and the comparison block, the portable terminal may determine lower similarity.

After shifting the difference block by one bit and determining that the bit value of the shifted difference block is “1”, the portable terminal increases the pixel difference number by one. Next, the portable terminal may determine the pixel difference for all of the difference blocks and determine the number of the “1”s of the difference blocks using the pixel difference number.

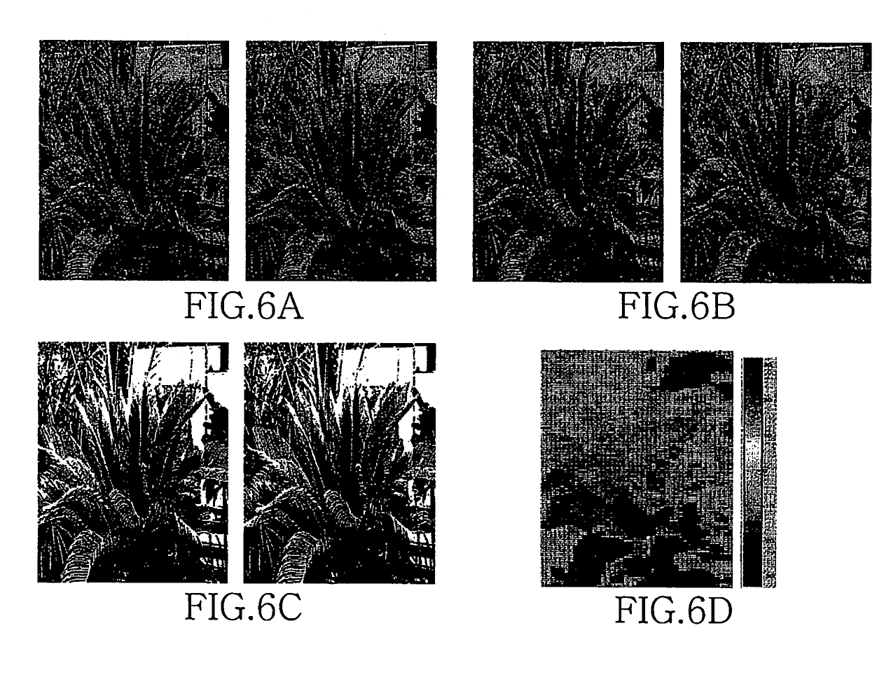

FIGS. 6A-6D are diagrams of the data processing method to determine the similar block in the portable terminal according to an embodiment of the present invention.

FIG. 6A shows the image data obtained through the two cameras in the portable terminal. The portable terminal selects one of the images obtained through the two cameras, as the reference image which is the basis for searching the blocks of the low similarity in the comparison image, which is the other image.

FIG. 6B shows data converted to a gray image using only intensity information in the portable terminal. The portable terminal converts the obtained image data of FIG. 6A to the gray image having only the intensity information.

FIG. 6C shows the gray data converted to the binary image in the portable terminal. The portable terminal converts the converted data of FIG. 6B to the binary image data.

FIG. 6D shows the block similarity determination in the portable terminal. For the greater pixel difference between the reference block and the comparison block, the portable terminal may determine the lower similarity. For a lesser pixel difference between the reference block and the comparison block, the portable terminal may determine the higher similarity.

As set forth above, the apparatus and the method for reducing computation in image data processing in a portable terminal, generates virtual frames of the image data constituted with binary data, and determines the similarity between the blocks by comparing the blocks of the generated virtual frames. By reducing the computation in the block similarity determination, it is possible to rapidly detect the similar blocks with less computation than the conventional portable terminal. Particularly, when the left and right images of a stereoscopic image, of which real-time processing is important, have a considerable similar block location difference, their similarity is determined with less computation to thus drastically enhance the performance of the terminal.

Although the present invention has been described with certain embodiments, various changes and modifications may be suggested to one skilled in the art. It is intended that the present invention encompass such changes and modifications as fall within the scope of the appended claims.

What is claimed is:

1. An apparatus for estimating block similarity of image data in a portable terminal, comprising:
a camera unit for obtaining two or more image data; and
a similar block detector for converting the obtained image data to binary data and estimating block similarity by comparing the converted binary data.

2. The apparatus of claim 1, wherein the similar block detector converts the image data to the binary data by setting a reference image among the obtained image data and comparing block data divided into a plurality of blocks with pixel-wise data of a comparison image.

3. The apparatus of claim 2, wherein the similar block detector divides the set reference image into a plurality of blocks, determines a DC average of the reference image through Discrete Cosine Transform (DCT), locates a first “1” from a Most Significant Bit (MSB) in a register comprising the DC average of the reference image, and generates blockwise data in which all of upper bits including the first “1” are set to “1”.

4. The apparatus of claim 3, wherein the similar block detector generates virtual frames used to determine the similarity by comparing the generated blockwise data with data of the comparison image.

5. The apparatus of claim 4, wherein the similar block detector compares the pixel-wise data of the comparison image with the DC average of the reference image, and generates the virtual frames with binary data by setting to 1 when the pixel-wise data is greater than the average DC and setting to zero when the pixel-wise data is less than the DC average.

6. The apparatus of claim 5, wherein the similar block detector stores the generated virtual frames to a memory, or divides a region of the memory in accordance with the virtual frames and then stores the virtual frames.

7. The apparatus of claim 2, wherein the similar block detector estimates the block similarity by comparing binary data of virtual frames corresponding to the reference image and the comparison image.

8. The apparatus of claim 7, wherein the similar block detector estimates the block similarity by generating a difference block produced by XOR-operating the binary data of the virtual frames corresponding to the reference image and the comparison image.

9. The apparatus of claim 8, wherein the similar block detector shifts the generated difference block by one, and estimates the block similarity by increasing a pixel difference number by one when a bit value of the shifted difference block is “1”.

10. The apparatus of claim 9, wherein the similar block detector determines a lower similarity for a greater pixel difference number.

11. A method for estimating block similarity of image data in a portable terminal, comprising:
obtaining two or more image data;
converting the obtained image data to binary data; and
estimating block similarity by comparing the converted binary data.

12. The method of claim 11, wherein converting the obtained image data to the binary data comprises:
generating block data divided into a plurality of blocks by setting a reference image among the obtained image data; and
converting to the binary data by comparing the generated block data with pixel-wise data of a comparison image.

13. The method of claim 12, wherein generating the block data divided into the plurality of blocks comprises:
dividing the set reference image into a plurality of blocks, determining a DC average of the reference image through Discrete Cosine Transform (DCT), locating a first “1” from a Most Significant Bit (MSB) in a register comprising the DC average of the reference image, and generating blockwise data in which all of upper bits including the first “1” are set to “1”.

14. The method of claim 13, wherein generating the block data divided into the plurality of blocks comprises:
generating virtual frames used to determine the similarity by comparing the generated blockwise data with data of the comparison image.

15. The method of claim 14, wherein generating the virtual frames compares the pixel-wise data of the comparison image with the DC average of the reference image, and generates the virtual frames with binary data by setting to 1 when the pixel-wise data is greater than the average DC and setting to zero when the pixel-wise data is less than the DC average

16. The method of claim 15, wherein the virtual frames generated with the binary data are stored to a memory, or to a region of the memory divided in accordance with the virtual frames.

17. The method of claim 12, wherein estimating the block similarity compares binary data of virtual frames corresponding to the reference image and the comparison image.

18. The method of claim 17, wherein estimating the block similarity comprises:
generating a difference block produced by XOR-operating the binary data of the virtual frames corresponding to the reference image and the comparison image; and
estimating the block similarity using the generated difference block.

19. The method of claim 18, wherein estimating the block similarity shifts the generated difference block by one, and estimates the block similarity by increasing a pixel difference number by one when a bit value of the shifted difference block is “1”.

20. The method of claim 19, wherein estimating the block similarity determines a lower similarity for a greater pixel difference number.
